(19) United States
(12) Patent Application Publication
(10) Pub. No.: US 2010/0141998 A1
(43) Pub. Date: Jun. 10, 2010

(54) IMAGE PROCESSING DEVICE, IMAGE PROCESSING METHOD, AND IMAGE FORMING APPARATUS

(75) Inventor: Koji Yanagisawa, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/630,745

(22) Filed: Dec. 3, 2009

(30) Foreign Application Priority Data
Dec. 4, 2008 (JP) 2008-309871

(51) Int. Cl. G06K 15/02

(52) U.S. Cl. 358/1.16; 358/1.18

(57) ABSTRACT

An image processing device includes: an image data division section that divides image data and generates divided image data; a first image processing section that performs image processing on the divided image data; a second image processing section that performs image processing on the divided image data; and an address assignment section that assigns addresses to first division data of the divided image data, which is image-processed by the first image processing section, and second division data of the divided image data which is image-processed by the second image processing section.

### CROSS-REFERENCES TO RELATED APPLICATIONS

Priority is claimed under 35 U.S.C. §119 to Japanese Application No. 2008-309871 filed on Dec. 4, 2008 which is hereby incorporated by reference in its entirety.

### BACKGROUND

1. Technical Field

The present invention relates to technical fields of an image processing device which performs image processing such as color conversion processing and screen processing on input image data, a method which performs the image processing on the image data, and an image forming apparatus which forms a latent image on a latent image carrier by using an exposure head having aligned light emitting elements.

2. Related Art

Generally, image forming apparatuses such as a printer include an image forming apparatus that forms an electrostatic latent image on a photoconductor by using a line head (for example, refer to JP-A-2008-137237). In the image forming apparatus disclosed in JP-A-2008-137237, an image processing controller performs image processing on the image data which is included in an image forming command, thereby forming video data. Then, light emitting elements of the line head are controlled to emit light on the basis of the video data, thereby forming an electrostatic latent image on a latent image carrier.

Further, generally, the image forming apparatuses such as a printer also include an image forming apparatus that achieves improvement in image quality by performing screen processing such as halftoning on the image data when printing the image data (for example, refer to JP-A-2008-153914). The image forming apparatus disclosed in JP-A-2008-153914 is configured to perform N-value conversion processing (halftone processing) on the image data by using a dither matrix of a threshold value of a screen pattern, thereby enabling high-quality image printing.

Recently, in the image forming apparatus using the line head, there has been a strong demand for increases in speed and increases in resolution. Hence, in image processing, increases in speed have also been demanded. However, the image processing data volume increases in accordance with the increase in resolution, and thus this hinders the increase in speed of the image processing. Moreover, there has been a demand that the image forming apparatus should have general versatility so as to flexibly cope with various high-resolution modes.

However, the image forming apparatus disclosed in JP-A-2008-137237 has no general versatility, and thus it is difficult to flexibly cope with various resolution modes. Further, since one-to-one data communication is established between the image processing controller and the head controller, it is difficult to achieve a higher speed in image processing. Further, when the screen processing is performed on the input image as disclosed in JP-A-2008-153914, it can be considered that the image data is divided and the screen processing is performed for each divided image data set.

However, when the screen processing is performed for each divided image data, it is difficult to say that the image processing controller is able to arrange the divided image data, which is image-processed, precisely in order of the divided image data. Hence, when the image processing is simply intended to be sequentially performed on each set of the divided image data, standby time is necessary for some divided image data to be arranged. As a result, time is necessary for the image processing to be performed on all the image data, and thus it is difficult to effectively cope with higher speeds. Accordingly, it can be considered that images are formed in the order the divided image data are arranged, but in this case, there is a concern that the images are formed in a state where the order of the divided image data is different.

### SUMMARY

An advantage of some aspects of the invention is that it provides an image processing device, an image processing method, and an image forming apparatus capable of promptly outputting the divided image data, which is reliably image-processed, while effectively achieving a higher speed in image processing.

In order to achieve the above-mentioned problems, in an image processing device, an image processing method, and an image forming apparatus according to aspects of the invention, an image data division section divides the input image data into the divided image data. Further, the image processing device has a first image processing section and a second image processing section. Accordingly, the image processing such as color conversion processing and screen processing can be independently performed in a parallel distributed manner on the divided image data by the first image processing section and the second image processing section. With such a configuration, it is possible to perform the image processing of high-resolution image data and a large volume of image data further promptly.

Further, when the divided image data on which the image processing is completed is optionally output from the first image processing section and second image processing section, the address assignment section assigns addresses to the divided image data. Accordingly, it is possible to output from the divided image data on which the image processing is completed, and thus it is not necessary to wait for the divided image data on which the image processing is not completed. Thereby, it is possible to eliminate image processing standby time, and thus it is possible to perform the image processing on the divided image data promptly. As a result, it is possible to cope with a higher speed in image processing effectively.

Then, an output is obtained from the divided image data on which the image processing is completed, thereby changing the order of the divided image data. However, since the address assignment section assigns addresses to the divided image data, at the time of recording a latent image by using an exposure head, it is possible to record the image in order from the head thereof without making errors in the order of the divided image data. Moreover, the divided image data are transmitted together with the absolute line number, and thus the address is directly designated by the first image processing section and the second image processing section, thereby not outputting the division image. Thereby, even when the line width of the divided image data is changed, it is possible to cope with the change in line width thereof flexibly. In such a manner, it is possible to output promptly the divided image data, which is reliably image-processed, while effectively achieving a higher speed in image processing.

### BRIEF DESCRIPTION OF THE DRAWINGS

The invention will be described with reference to the accompanying drawings, wherein like numbers reference like elements.

FIG. 1 is a diagram schematically and partially illustrating an example of an image forming apparatus according to an embodiment of the invention.

FIG. 2 is a partial perspective view illustrating a line head of the example shown in FIG. 1.

FIG. 3 is a block diagram illustrating an engine control section and an engine section of the example shown in FIG. 1.

FIG. 4 is a block diagram schematically illustrating a main controller and an image processing controller.

FIG. 5 is diagram illustrating line data to which an absolute line number is assigned.

FIG. 6A is a diagram illustrating an example of divided image data which is color-developed into YMCK for each pixel.

FIG. 6B is a diagram illustrating an example of divided image data which is sorted by color.

FIG. 7A is a diagram illustrating transmission of band data.

FIG. 7B is a diagram illustrating an order of transmission of the line data.

FIG. 8 is a diagram illustrating a specific example of the transmission of the line data.

### DESCRIPTION OF EXEMPLARY EMBODIMENT

Hereinafter, embodiments of the invention will be described with reference to the accompanying drawings.

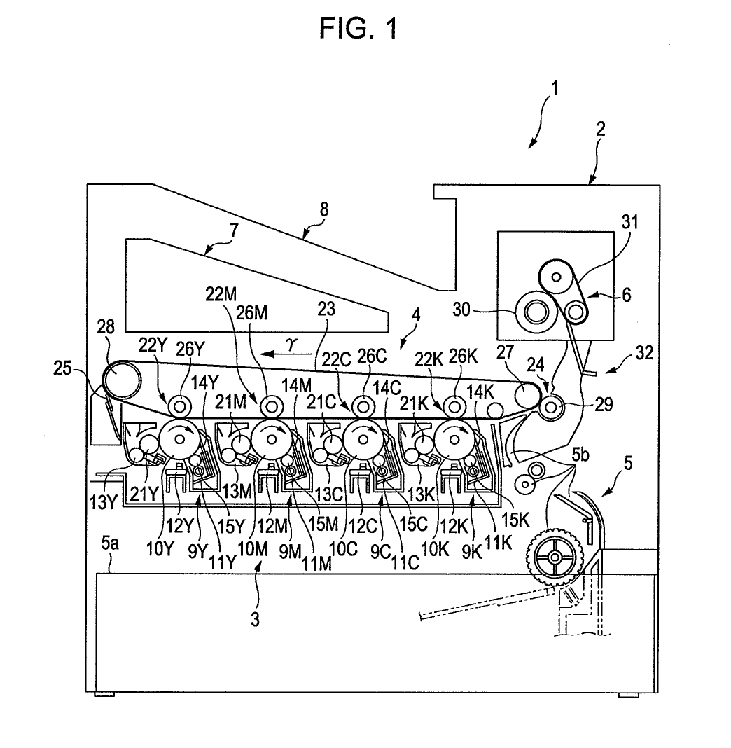

FIG. 1 is a diagram schematically and partially illustrating an example of an image forming apparatus according to an embodiment of the invention.

As shown in FIG. 1, the exemplary image forming apparatus 1 includes a housing body 2. The housing body 2 includes an image forming unit 3, a transfer section 4, a transfer material supply section 5 for containing transfer materials such as transfer papers, a fixing section 6, an engine control section 7, and a paper discharging tray 8.

The image forming unit 3 includes a first image forming station 9Y which is an image forming station of yellow (Y), a second image forming station 9M which is an image forming station of magenta (M), a third image forming station 9C which is an image forming station of cyan (C), and a fourth image forming station 9K which is an image forming station of black (K). The first to fourth image forming stations 9Y, 9M, 9C, and 9K are arranged in a tandem in this order. Furthermore, the arrangement order of the first to fourth image forming stations 9Y, 9M, 9C, and 9K is optional. Hereinafter, the first to fourth image forming stations 9Y, 9M, 9C, and 9K are described in the arrangement order shown in FIG. 1.

All the first to fourth image forming stations 9Y, 9M, 9C, and 9K have the same configuration. Accordingly, the first image forming station 9Y of yellow (Y) is described, and detailed description of the second to fourth image forming stations 9M, 9C, and 9K of different colors will be omitted. Furthermore, the respective components of the second to fourth image forming stations 9M, 9C, and 9K are referenced by the reference numerals and signs, to which the indexes of M, C, and K are added, the same as those of the corresponding components of the image forming station 9Y of yellow (Y).

The first image forming station 9Y has a first photoconductor 10Y as a latent image carrier. Further, the first image forming station 9Y has, around the first photoconductor 10Y, a first charging section 11Y, a first line head 12Y as an exposure head of an image recording section, a first development section 13Y, and a first photoconductor cleaner 14Y.

The first charging section 11Y includes a first charging roller 15Y which is generally used. The first charging roller 15Y is operable to charge the surface of the first photoconductor 10Y with a preset surface electric potential.

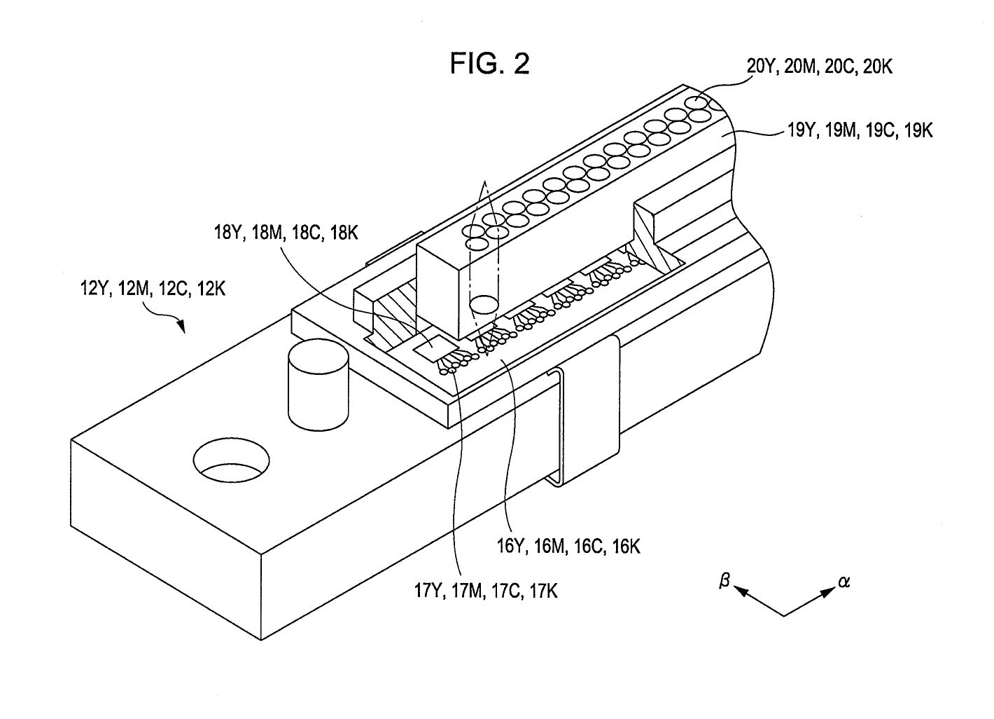

As shown in FIG. 2, the first line head 12Y has a first base substrate 16Y, a first LED array 17Y, a first driver IC 18Y, and a first rod lens array 19Y. The first LED array 17Y includes LED elements as light emitting elements. In this case, the LED elements are arranged on the first base substrate 16Y along a first direction a (a so-called main scanning direction) orthogonal to the transport direction (the moving direction) of the transfer material.

Further, the first drivers IC 18Y are arranged on the first base substrate 16Y so as to be adjacent to the LED elements in a second direction β (a so-called sub-scanning direction) which is the same or substantially the same as the transport direction of the transfer material, and are arranged along the first direction α. In this case, one first driver IC 18Y is connected to a preset number of LED elements. Accordingly, the one first driver IC 18Y is configured to drive the LED elements connected thereto. In this case, when receiving the video signal from the head controller 36 to be described later, the LED elements are configured to emit light by driving the first driver IC 18Y on the basis of the video signal.

The first rod lens array 19Y has first gradient index rod lenses 20Y. The first gradient index rod lenses 20Y are arranged in two rows in a staggered manner along the first direction α, and are arranged to face the LED elements. In addition, the first gradient index rod lens 20Y is configured to optically form an image of the light emitted from the LED element, expose the first photoconductor 10Y, and form an electrostatic latent image of yellow (Y) on the first photoconductor 10Y. Furthermore, the first gradient index rod lens 20Y is not limited to two rows, and may be optionally arranged in three or more rows.

The first development section 13Y has a first development roller 21Y. The first development roller 21Y is operable to supply a toner of yellow (Y) to the first photoconductor 10Y. The electrostatic latent image of the first photoconductor 10Y is developed by the toner, and the toner image of yellow (Y) is formed on the first photoconductor 10Y.

The first photoconductor cleaner 14Y is operable to clean the first photoconductor 10Y to which the toner image is transferred.

As shown in FIG. 1, the transfer section 4 has a first transfer section 22Y of yellow (Y), a second transfer section 22M of magenta (M), a third transfer section 22C of cyan (C), a fourth transfer section 22K of black (B), an endless transfer belt 23 as a transfer medium, a fifth transfer section 24, and a transfer belt cleaner 25.

The first transfer section 22Y has a first transfer roller 26Y. Further, the second transfer section 22M has a second transfer roller 26M. The third transfer section 22C has a third transfer roller 26C. The fourth transfer section 22K has a fourth transfer roller 26K. The first to fourth transfer rollers 26Y, 26M, 26C, and 26K presses the transfer belt 23 so as to be in contact with the corresponding first to fourth photoconductor 10Y, 10M, 10C, and 10K. In addition, the rollers are operable to transfer the toner images of the first to fourth photoconductors 10Y, 10M, 10C, and 10K to the transfer belt 23 by the first to fourth transfer biases.

The transfer belt 23 is stretched on a driving roller 27 and a driven roller 28, and is rotated by the driving roller 27 in an arrow direction γ.

The fifth transfer section 24 has a fifth transfer roller 29. The fifth transfer roller 29 is operable to press the transfer material so as to be in contact with the transfer belt 23, and is operable to transfer the toner image of the transfer belt 23 to the transfer material by a fifth transfer bias.

The transfer belt cleaner 25 is operable to clean the transfer belt 23 to which the toner image is transferred.

The transfer material supply section 5 has a transfer material containing section 5a that contains the transfer material such as a transfer paper, and a transfer material supply section 5b that supplies the transfer material from the transfer material containing section 5a to the fifth transfer section 24. The transfer material supply section 5 is operable to supply the transfer material one by one from the transfer material containing section 5a to the fifth transfer section 24 at the time of image formation.

The fixing section 6 has a heating roller 30 and a press belt 31. The press belt 31 is operable to press the transfer material, to which the toner image is transferred by the fifth transfer section 24, to the heating roller 30. The heating roller 30 is operable to heat the toner-image-transferred surface of the transfer material. Thereby, the toner image is fixed on the toner material, thereby forming an image on the transfer material.

The image forming unit 3, the transfer section 4, the transfer material supply section 5, and the fixing section 6 constitute an engine section 32 of the image forming apparatus 1.

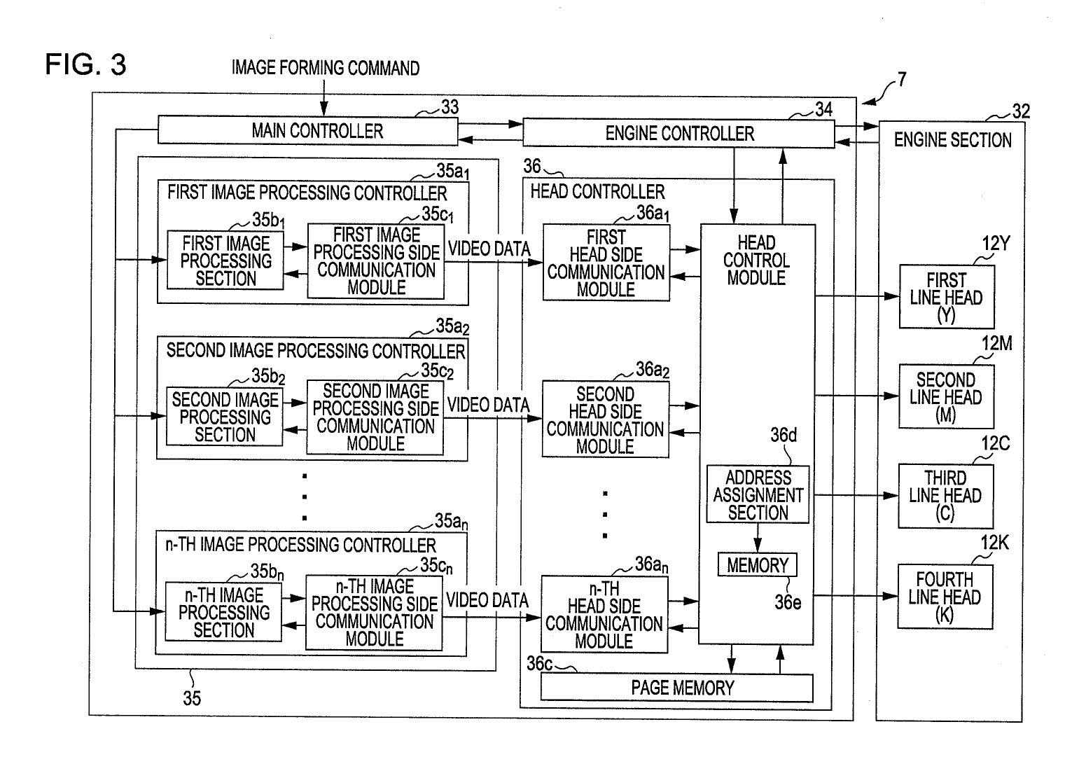

An engine control section 7 is configured to control the engine section 32. As shown in FIG. 3, the engine control section 7 has a power supply circuit substrate (not shown in the drawing), a main controller 33, an engine controller 34, an image processing controller 35, and a head controller 36. In addition, the main controller 33, the image processing controller 35, and the head controller 36 constitute an image processing device.

When an external device (not shown in the drawing) such as a host computer issues an image forming command, the main controller 33 transmits a control signal for activating the engine section 32 to the engine controller 34 via a UART (Universal Asynchronous Receiver/Transmitter) communication line.

When receiving the control signal from the main controller 33, the engine controller 34 starts initialization and warm up of the engine section 32. Then, when the initialization and the warm up is completed and the image forming operation becomes feasible, the engine controller 34 outputs a synchronous signal, which functions as a trigger for starting the image forming operation, to the head controller 36 via the UART communication line. Then, through the communication between the engine controller 34 and the head controller 36, not only the synchronous signal is transmitted, but also signals of various control parameters for controlling the line heads 12Y, 12M, 12C, and 12K are exchanged (Furthermore, the exchange of the signals of the control parameters is performed in the same manner as the image forming apparatus disclosed in the above-mentioned JP-A-2008-137237, and thus detailed description is omitted).

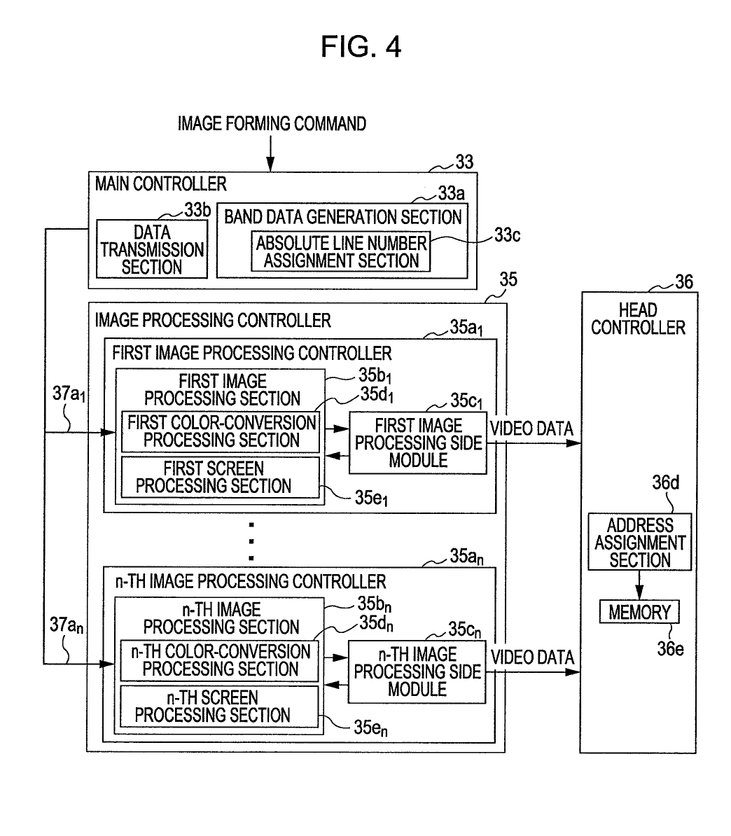

Then, as shown in FIG. 4, the main controller 33 has a band data generation section 33a as an image data division section and a data transmission section 33b. The band data generation section 33a is configured to generate divided image data, which is obtained by dividing image data included in the image forming command into first to m-th band data of the m (m≧1) lines in the second direction (a divided-image-data generation process).

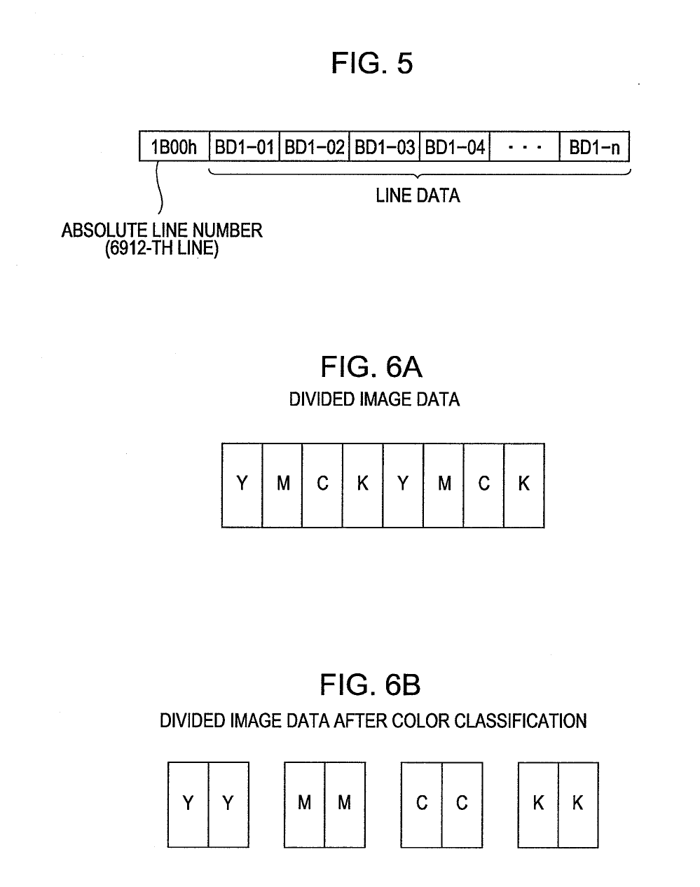

Further, the band data generation section 33a has an absolute line number assignment section 33c. The absolute line number assignment section 33c is configured to assign an absolute line number of the head line to each band data as shown in FIG. 5. The absolute line number indicates which line within one page the line data belongs to. In the example shown in FIG. 5, the absolute line number “1B00h” is assigned to the head of the line data of one line, and the absolute line number “1B00h” indicates the line data of 6912-th line.

The divided image data used in the image forming apparatus 1 of the example is interleaved image data. For example, when the image data are YMCK image data of yellow (Y), magenta (M), cyan (C), and black (K), the interleaved image data are defined as image data of 8 bits (256 gray scales) in which the YMCK image data are color-developed and sorted by the four toner colors of the YMCK for each pixel as shown in FIG. 6A. The divided image data are formed of data of several pixels for one line. The image data within one page is formed as band data by dividing the image data into m lines in the second direction (the sub-scanning direction) as described above. Accordingly, the divided image data are not data in a format in which data are sorted by the respective colors of yellow (Y), magenta (M), cyan (C), and black (K).

The data transmission section 33b is configured to transmit the band data to the image processing controller 35. However, at the time of the transmission of the band data, the data transmission section 33b transmits the line data of one line to the image processing controller 35, together with the absolute line number assigned to the line data.

As shown in FIGS. 3 and 4, the image processing controller 35 has n number of first to n-th image processing controllers 35a₁ to 35aₙ. Further, the first image processing controller 35a₁ has a first image processing section 35b₁ and a first image processing side communication module 35c₁. As shown in FIG. 4, the first image processing section 35b₁ has a first color conversion processing section 35d₁ and a first screen processing section 35e₁. It is the same as other image processing controllers. For example, the n-th image processing controller 35aₙ as an n-th image processing section has an n-th image processing section 35bₙ and an n-th image processing side communication module 35cₙ. In addition the n-th image processing section 35bₙ has an n-th color conversion processing section 35dₙ and an n-th screen processing section 35eₙ. In this case, the first to n-th image processing controllers 35a₁ to 35aₙ are independently driven.

The data transmission section 33b of the main controller 33 is configured to transmit (assign) the first to m-th band data, in this order, to the first to n-th image processing sections 35b₁ to 35bₙ through the first to n-th transmission lines 37a₁ to 37aₙ.

When the band data are transmitted, the first to n-th image processing sections 35b₁ to 35bₙ perform the color conversion processing (the first image processing process and the second image processing process) first on the band data which is transmitted to the first to n-th color conversion processing sections 35d₁ to 35dₙ. The color conversion processing is processing that converts the band data into the color gamut (the gamut of colors (within a limit range) which can be reproduced by the image forming apparatus 1) of the image forming apparatus 1. The color conversion processing is performed by interpolation calculation on the basis of a color conversion LUT (look-up table: conversion matrix into the color gamut of the image forming apparatus 1). In addition, the data size after the color conversion processing is 8 bits for each of the colors the same as before the color conversion processing.

Next, the first to n-th image processing sections 35b₁ to 35bₙ perform the screen processing on the band data, on which the color conversion processing is performed, by the first to n-th screen processing sections 35e₁ to 35eₙ (the first image processing process and the second image processing process). The screen processing is processing that converts pixels in the band data, on which the color conversion processing is performed, into information (that is, information as to whether or not the line head emits light) on ON/OFF states of dots. The screen processing determines the ON/OFF states of the dots on the basis of the screen LUT (the threshold matrix which determines the ON/OFF states of the dots). The data size after the screen processing is 1 bit for each of the colors.

The first to n-th image processing side communication modules 35c₁ to 35cₙ receive the first to m-th band data from the main controller 33. Then, when receiving the band data from the main controller 33, the first to n-th image processing side communication modules 35c₁ to 35cₙ transmit the band data to the first to n-th color conversion processing sections 35d₁ to 35dₙ of the first to n-th image processing sections 35b₁ to 35bₙ.

Further, the first to n-th image processing side communication modules 35c₁ to 35cₙ optionally output the line data, on which the screen processing is completed by the first to n-th screen processing sections 35e₁ to 35eₙ, to the first to n-th head side communication module 36a₁ to 36aₙ.

Furthermore, FIG. 3 shows that the line data from the main controller 33 is directly transmitted to the first to n-th image processing sections 35b₁ to 35bₙ. However, in the engine control section 7 of the example, practically, the line data from the main controller 33 is transmitted to the first to n-th image processing sections 35b₁ to 35bₙ via the first to n-th image processing side communication modules 35c₁ to 35c_{c}.

As shown in FIG. 3, the head controller 36 has a first head side communication module 36a₁, a second head side communication module 36a₂, . . . , and an n-th head side communication module c36aₙ. Further, the head controller 36 has a head control module 36b and a page memory 36c.

The first image processing side communication module 35c₁ and the first head side communication module 36a₁ are configured to enable bidirectional communication. Likewise, other image processing side communication modules and other head side communication modules are configured to enable the bidirectional communication. For example, the n-th image processing side communication module 35cₙ and the n-th head side communication module 36aₙ are also configured to enable the bidirectional communication.

The head control module 36b has an address assignment section 36d and a memory 36e. The address assignment section 36d is configured to assign memory addresses to the line data of the band data input to the head controller 36. In this case, the address assignment section 36d calculates the memory address from the absolute line number assigned to the line data. Accordingly, the memory addresses are associated therewith in the order of the line data transmitted from the main controller 33.

Further, the memory 36e is configured to store the memory addresses. The memory 36e is configured to store the line data, to which the memory addresses are assigned by the address assignment section 36d, in the corresponding memory addresses in the memory 36e. That is, the line data, to which the memory addresses are assigned, are recorded on the corresponding memory addresses in the memory 36e. Accordingly, the line data are optionally input to the head controller 36 in the order in which the image processing is completed by the image processing controller 35, but the line data are not input in the order that the data are transmitted from the main controller 33.

When the line data corresponding to one page is stored in the memory 36e, the line data are read out in the order of the memory addresses corresponding to the order of the line data. Thereby, although the line data are not input from the image processing controller 35 to the head controller 36 in the order in which the data are transmitted from the main controller 33, the order of line data is reliably the same as the order in which the data are transmitted from the main controller 33.

Then, the line data are transmitted and stored in a yellow page data memory portion, a magenta page data memory portion, a cyan page data memory portion, and a black page data memory portion, which are not shown in the drawing, of the page memory 36c.

In this case, when the line data are transmitted to the page data memory portions, data sorting for each color necessary for the line head is performed, thereby generating the line data of the respective colors. Then, the head control module 36b acquires the line data from the page memory 36c upon request and outputs the data to the first to fourth line heads 12Y, 12M, 12C, and 12K of the corresponding colors. Thereby, the first to fourth line heads 12Y, 12M, 12C, and 12K record the respective color images on the first to fourth photoconductors 10Y, 10M, 10C, and 10K in accordance with the supplied line data.

A specific example of the image processing and the transmission/reception of the image data in the image forming apparatus 1 of the example will be described.

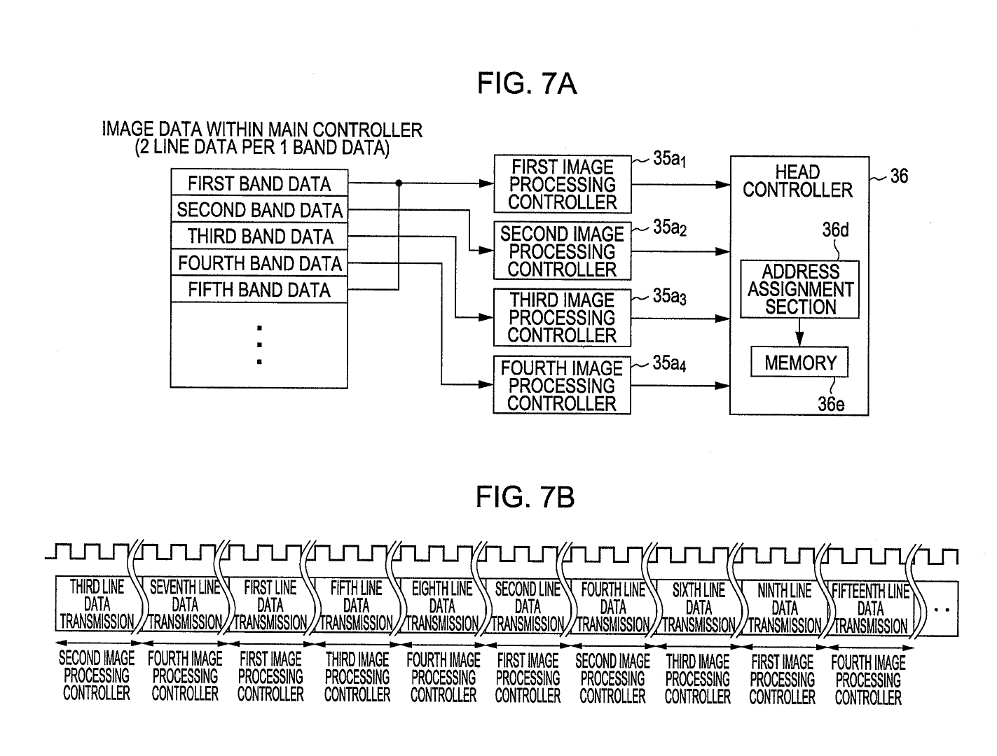

As shown in FIG. 7A, in the specific example, the engine control section 7 of the image forming apparatus 1 has four first to fourth image processing controllers 35a₁ to 35a₄. Further, the image data in the main controller 33 has two line data per one band data.

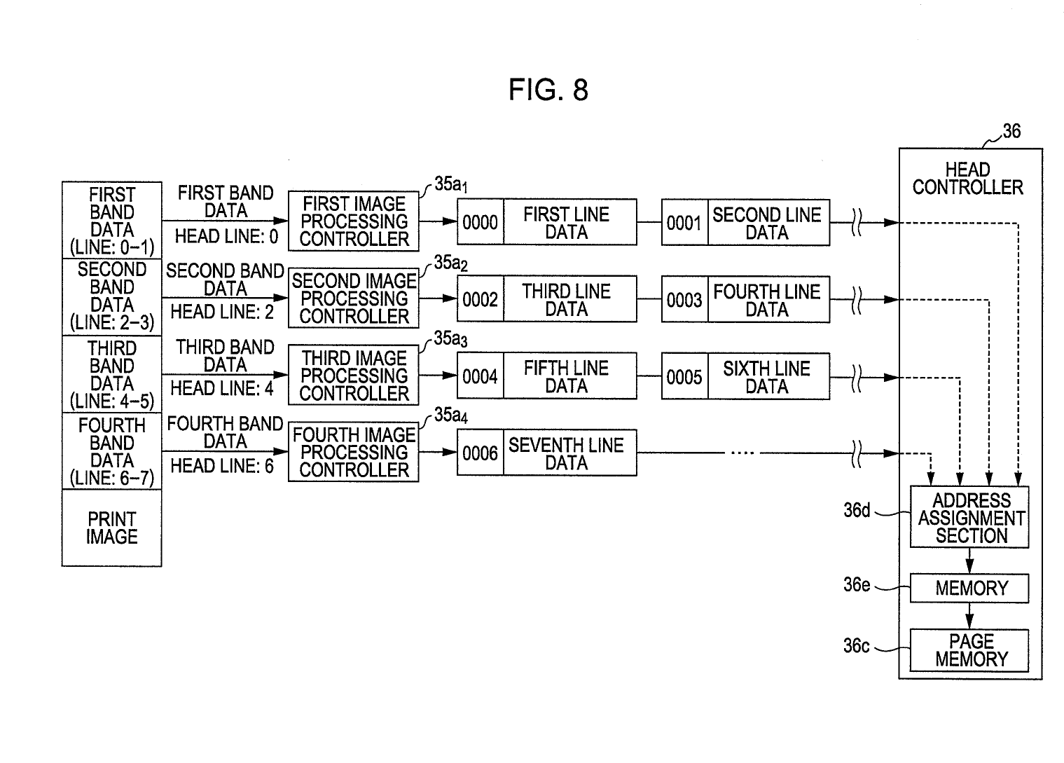

In this case, as shown in FIG. 8, the first band data corresponds to the lines 0-1. Further, the second band data corresponds to the lines 2-3. The third band data corresponds to the lines 4-5. In addition, the fourth band data corresponds to lines 6-7.

Further, as shown in FIG. 8, the absolute line number “0000” is assigned to the first line data of the first band data, and the absolute line number “0001” is assigned to the second line data of the first band data. Likewise, the absolute line number “0002” is assigned to the third line data of the second band data, and the absolute line number “0003” is assigned to the fourth line data of the second band data. In addition, the absolute line number “0004” is assigned to the fifth line data of the third band data, and the absolute line number “0005” is assigned to the sixth line data of the third band data. In addition, the absolute line number “0006” is assigned to the seventh line data of the fourth band data, and the absolute line number “0007” is assigned to the eighth line data of the fourth band data. Furthermore, in FIG. 8, the eighth line data and the absolute line number “0007” thereof are omitted in the drawing. These absolute line numbers are numbers associated with the lines of the image data corresponding to one page.

Then, the memory addresses are calculated as follows. For example, it is assumed that the number of dots of the line heads is 10000, and 8-bit line data, which is received by the head controller 36, is directly stored. In this case, the memory address of the first line data of the first band data is calculated to be “00000” from the calculation formula of 0×4×10000. Here, “0” in the calculation formula represents the first line, and the absolute line number “0000” corresponds thereto. Further, the memory address of the second line data of the first band data is calculated to be “40000” from the calculation formula of 1×4×10000. Here, “1” in the calculation formula represents the second line, and the absolute line number “0001” corresponds thereto. In addition, the memory address of the third line data of the second band data is calculated to be “80000” from the calculation formula of 2×4×10000. Here, “2” in the calculation formula represents the third line, and the absolute line number “0002” corresponds thereto. In addition, the memory address of the fourth line data of the second band data is calculated to be “120000” from the calculation formula of 3×4×10000. Here, “3” in the calculation formula represents the fourth line, and the absolute line number “0003” corresponds thereto. In addition, the memory address of the fifth line data of the third band data is calculated to be “160000” from the calculation formula of 4×4×10000. Here, “4” in the calculation formula represents the fifth line, and the absolute line number “0004” corresponds thereto. In addition, the memory address of the sixth line data of the third band data is calculated to be “200000” from the calculation formula of 5×4×10000. Here, “5” in the calculation formula represents the sixth line, and the absolute line number “0005” corresponds thereto. In addition, the memory address of the seventh line data of the fourth band data is calculated to be “240000” from the calculation formula of 6×4×10000. Here, “6” in the calculation formula represents the seventh line, and the absolute line number “0006” corresponds thereto. In addition, the memory address of the eighth line data of the fourth band data is calculated to be “280000” from the calculation formula of 7×4×10000. Here, “7” in the calculation formula represents the eighth line, and the absolute line number “0007” corresponds thereto.

The first band data is transmitted from the main controller 33 to the first image processing controller 35a₁. Further, the second band data is transmitted to the second image processing controller 35a₂. In addition, the third band data are transmitted to the third image processing controller 35a₃. In addition, the fourth band data are transmitted to the fourth image processing controller 35a₄. In addition, the fifth band data are transmitted to the first image processing controller 35a₁ again. Although the following description thereof is omitted, the band data from the main controller 33 are sequentially transmitted to the first to fourth image processing controllers 35a₁ to 35a₄ as described above.

In this case, first, the first line data of the first band data are transmitted to the first image processing controller 35a₁, and then the second line data of the first band data are transmitted to the first image processing controller 35a₁. Subsequently, the third line data of the second band data are transmitted to the second image processing controller 35a₂, and then the fourth line data of the second band data are transmitted to the second image processing controller 35a₂. Subsequently, the fifth line data of the third band data are transmitted to the third image processing controller 35a₃, and then the sixth line data of the third band data are transmitted to the third image processing controller 35a₃. Subsequently, the seventh line data of the fourth band data are transmitted to the fourth image processing controller 35a₄, and then the eighth line data of the fourth band data are transmitted to the fourth image processing controller 35a₄. Subsequently, the ninth line data of the fifth band data are transmitted to the first image processing controller 35a₁ again, and then the tenth line data of the fifth band data are transmitted to the first image processing controller 35a₁. Hereinafter, in the same manner as described above, the line data of the band data are sequentially transmitted to the image processing controllers.

In the image processing in the image processing controller 35, for example, the image processing of the third line data performed by the second image processing controller 35a₂ may be completed first as shown in FIG. 7B. Then, the second image processing controller 35a₂ outputs the third line data to the head controller 36. The third line data are transmitted to the address assignment section 36d of the head controller 36. Then, the address assignment section 36d assigns the memory address of “80000” to the third line data.

Next, as shown in FIG. 7B, the image processing of the seventh line data performed by the fourth image processing controller 35a₄ may be completed. Then, the fourth image processing controller 35a₄ outputs the seventh line data to the head controller 36. Likewise, the address assignment section 36d assigns the memory address of “240000” to the seventh line data.

Subsequently, the image processing of the first data performed by the first image processing controller 35a₁ may be completed. Then, the first image processing controller 35a₁ outputs the first line data to the head controller 36. Likewise, the address assignment section 36d assigns the memory address of “00000” to the first line data.

Next, the image processing of the fifth line data performed by the third image processing controller 35a₃ may be completed. Then, the third image processing controller 35a₃ outputs the fifth line data to the head controller 36. Likewise, the address assignment section 36d assigns the memory address of “160000” to the fifth line data.

Hereinafter, as shown in FIG. 7B, the line data on which the image processing is completed are optionally output from the image processing controller, which performs the image processing on the line data, to the head controller 36. Then, the address assignment section 36d of the head controller 36 assigns the calculated memory addresses to the transmitted line data.

The head controller 36 outputs the line data of the band data corresponding to one page to the first to fourth line heads 12Y, 12M, 12C, and 12K of the colors corresponding to the line data as described above. Thereby, the first to fourth line heads 12Y, 12M, 12C, and 12K record the respective color image on the first to fourth photoconductors 10Y, 10M, 10C, and 10K in accordance with the supplied line data.

According to the image processing device, the image processing method, and the image forming apparatus 1 of the example, the image processing controller 35 has the first to n-th image processing controllers 35a₁ to 35aₙ. Accordingly, the line data or the band data, which is the divided image data obtained by dividing the input image data, can be independently image-processed by the first to n-th image processing controllers 35a₁ to 35aₙ in the parallel distributed manner. With such a configuration, it is possible to perform the image processing of high-resolution image data and a large volume of image data further promptly.

Further, the head controller 36 has the address assignment section 36d and the memory 36e. Then, when the line data on which the image processing is completed is optionally output from the image processing controller 35 to the head controller 36, the address assignment section 36d assigns the associated memory addresses to the line data in the order of the line data which are obtained by dividing the image data. The line data, to which the memory addresses are assigned, are recorded on the corresponding memory addresses in the memory 36e. Accordingly, since the line data, on which the image processing is completed, are output to the head controller 36 first, it is not necessary to wait for the line data on which the image processing is not completed. Thereby, it is possible to eliminate image processing standby time, and thus it is possible to perform the image processing on the line data promptly. As a result, it is possible to cope with a higher speed in image processing effectively.

In addition, since the line data, on which the image processing is completed, are output to the head controller 36 first, the order of the line data is changed. However, since the address assignment section 36d of the head controller 36 assigns the associated memory addresses to the line data in the order of the line data which are obtained by dividing the image data, at the time of recording a latent image by using the line head, it is possible to record the image in order from the head thereof without making errors in the order of the line data. Moreover, the absolute line number is output (notified) together with the line data from the image processing controller 35 to the head controller 36, and thus the memory address is directly designated to the head controller 36 by the image processing controller 35, thereby not outputting the line data. Thereby, even when the line width of the line data is changed, it is possible to cope with the change in line width thereof flexibly. In such a manner, it is possible to output promptly the divided image data, which is reliably image-processed, while effectively achieving a higher speed in image processing.

Furthermore, other components and other image operations in the image forming apparatus 1 of the example are practically the same as the image forming apparatus disclosed in JP-A-2008-137237, and therefore description thereof will be omitted.

Further, the invention is not limited to the examples mentioned above, and may be modified into various forms. For example, it may be not necessary to sequentially transmit the band data, which is divided by the main controller 33, to the image processing controller 35, and the band data may be transmitted in an optional order. Further, page memory 36c and the memory 36e for storing the line data to which the memory address is assigned may be formed as one memory. The bottom line is, modifications, derivations, and variations can be made without departing from the technical scope described in the claims appended hereto.

The entire disclosure of Japanese Patent Application No: 2008-309871, filed Dec. 4, 2008 is expressly incorporated by reference herein.

What is claimed is:

1. An image processing device comprising:
an image data division section that divides image data and generates divided image data;
a first image processing section that performs image processing on the divided image data;
a second image processing section that performs image processing on the divided image data; and
an address assignment section that assigns addresses to first division data of the divided image data, which is image-processed by the first image processing section, and second division data of the divided image data which is image-processed by the second image processing section.

2. The image processing device according to claim 1, further comprising an absolute line number assignment section that assigns an absolute line number, which corresponds to a line of the divided image data, to the divided image data divided by the image data division section.

3. The image processing device according to claim 2, wherein the address is calculated on the basis of the absolute line number.

4. The image processing device according to claim 1, further comprising a memory that stores line data to which the address is assigned.

5. An image processing method comprising:
a divided-image-data generation process that divides image data and generates divided image data;
a first image processing process that performs image processing on first division data of the divided image data;
a second image processing process that performs image processing on second division data of the divided image data; and
an address assignment process that assigns addresses to the first division data and the second division data which are image-processed.

6. An image forming apparatus comprising:
a latent image carrier on which a latent image is formed;
an exposure head that forms the latent image, which is based on image data, on the latent image carrier;
an image data division section that divides image data and generates divided image data;
a first image processing section that performs image processing on the divided image data;
a second image processing section that performs image processing on the divided image data; and
an address assignment section that assigns addresses to first division data of the divided image data, which is image-processed by the first image processing section, and second division data of the divided image data which is image-processed by the second image processing section.
